(19) United States
(12) Patent Application Publication
(10) Pub. No.: US 2025/0235380 A1
(43) Pub. Date: Jul. 24, 2025

(54) LAVA BATHING-SPA DEVICE

(71) Applicant: Shota KOIZUMI, Setagaya-ku, Tokyo (JP)

(72) Inventor: Shota KOIZUMI, Setagaya-ku, Tokyo (JP)

(21) Appl. No.: 18/700,949

(22) PCT Filed: Oct. 7, 2022
(86) PCT No.: PCT/JP2022/037610

§ 371 Date: Apr. 12, 2024

(30) Foreign Application Priority Data
Oct. 13, 2021 (JP) 2021-168338

(51) Int. Cl. A61H 33/06; A61H 33/00

(52) U.S. Cl. CPC A61H 33/065; A61H 33/0095; A61H 33/067; A61H 2033/068; A61H 2201/0221

(57) ABSTRACT

To elicit a hot-bath effect to be able to be sufficiently enjoyed simply and easily with less stress than a conventional sauna and cause deep inside the body to be warmed with comfort as never experienced before. In order to realize this, a lava bathing-spa device 1 includes a heat/steam generating device 20 which is installed in a spa room 10 including a door 15 capable of being opened/closed and which generates heat and steam, an interior material 16RP which contains ores generating far infrared rays, and which is installed in the spa room 10, and a heating device which heats the interior material 16RP from inside or a back side thereof.

### TECHNICAL FIELD

This disclosure relates to a lava bathing-spa device.

### BACKGROUND ART

Recently, leisure facilities having baths and spas have been constructed one after another, and various hot bath facilities attract more and more people nowadays as easy and familiar relaxation facilities.

One of those hot bath facilities is bedrock bathing which warms deep inside the body by using far infrared rays emitted from the bedrock (see Patent Document 1, for example). Moreover, facilities have been provided in which elements such as music, natural sounds, mists, and visual effects are delicately combined with characteristics of the bedrock bathing so as to elicit further healing (comforting) effects and to further improve comfortableness.

Moreover, as a hot bath facility which has gained a lot of popularity in recent years, sauna can be exemplified (see Patent Document 2, for example). Particularly in these several years, there have been a lot of media coverage and special features on sauna, whereby chances to come across sauna lovers' terms such as “Saunner” and “Totonou” (state of physical relaxation and mental calmness after taking sauna) have increased, and the sauna has become so popular that it could be said today that its third boom has arrived. It is needless to say that the sauna is one of facilities for a steam bath/hot air bath (steam bath), which is considered to have originated in Finland and is constituted such that a stove on which a large number of stones called sauna stones are loaded is heated, and a temperature and humidity in a room is regulated by the heat and steam generated by watering the stones so that heavy perspiration is prompted.

### CITATION LIST

### Patent Document

Patent Document 1: Patent Publication JP-A-2013-94610

Patent Document 2: Japanese Utility Model Registration No. 3229179

### SUMMARY

### Technical Problem

However, though the sauna has gain popularity as above, and the number of sauna lovers seems to be increasing, it is not difficult to imagine there is a certain rate of users who do not necessarily enjoy the comfortableness totally from the bottoms of hearts without feeling any kind of painfulness during use of the sauna. That is because the inventor is also one of such people who feel slight hardship and has a kind of feeling of pressure, e.g., heavy perspiration cannot be achieved without enduring the heat in a hot room. That is, the sauna is constituted such that the heavy perspiration is caused by staying for some minutes in a room in which an indoor temperature is set to 90 to 100° C. and humidity to approximately 20%, for example, and moreover, this is still the case of the “Finnish-style sauna” whose indoor environment is considered to be relatively mild, and in the case of a so-called dry-type sauna, the temperature is 80 to 90° C. and the humidity is extremely as low as approximately several %, which could damage mucosa of a nose or a throat, an airway or a lung, and in order to perspire in a high-temperature/dry state, it is required to stay in a severe environment accompanied by harsh physical loads. For the sauna lovers, only after putting up with staying in the environment as above, an unextraordinary euphoric feeling can be obtained in a water bath (alternate hot/cold bath) or outside-air bath, but inexperienced sauna users, in particular, beginners, may have a long way to go to have at such a feeling.

Thus, this disclosure has an object to provide a lava bathing-spa device which can be enjoyed more simply and easily and causes less stress than the conventional sauna and by which a hot-bath effect of warming deep inside the body can be sufficiently enjoyed with comfort as never experienced before.

### Solution to Problem

In order to solve the problem as above, the inventor repeatedly conducted various examinations and tests. In the first place, the sauna is to create an environment of a so-called steam bath at a high temperature and high humidity, which promotes perspiration (however, in the case of a dry type, it is a high-temperature low-humidity environment with the humidity of approximately 0 to 10%) and thus, a considerably high-temperature and high humidity environment has to be provided. On the other hand, in the bedrock bathing in which the healing effect is pursued and comfortableness is improved, a long-time stay causes no hardship, but its object is not perspiration as in the sauna, or its purpose and target are different from the first place. The inventor paid attention to and further examined the sauna and the bedrock bathing whose purposes and structures are so different, though they are both facilities of similar hot bath leisure facilities, and reached a finding based on an idea of newly creating such an unexperienced zone that warms deep inside the body with comfort as never experienced before. That is, the inventor has obtained a new finding in which, in the conventional sauna a so-called 2-axis approach is implemented by which a physical feeling and an effect are created by setting of the room temperature and the humidity, but if a 3-axis approach of the room temperature, the humidity and, in addition, a far-infrared radiant heat is implemented by which a hot-bath effect is elicited, then sauna can be enjoyed simply and easily with less stress than the conventional sauna, and comfort as never experienced before becomes available.

The lava bathing-spa device according to this disclosure based on the finding as above includes: a heat/steam generating device which is installed inside a spa room including a door capable of being opened/closed, and which generates heat and steam; an interior material which contains ores generating far infrared rays, and which is installed in the spa room; and a heating device which heats the interior material from an inside or a back side thereof. The lava bathing-spa device as above can be said to include a configuration required to realize unique effects that could not be fully exerted with the conventional hot bath facilities such as raising of a physical sensation and an effect thereof to higher levels, and enabling heat to approach deep inside the body due to the effect unique to the far-infrared radiant heat and, as a result, quickening high perspiration and activities of metabolism by utilizing the far-infrared radiant heat, even though its temperature is lower than the conventional (Finnish-style) sauna. When the hot bath environment created by the lava bathing-spa device as above is compared to a bath, the conventional Finnish-style sauna is a bath using tap water in a high-temperature state, while the lava bathing-spa device according to this disclosure is to take a bath of hot spring at a lowered temperature.

The lava bathing-spa device as above may provide an indoor environment such that a room temperature, humidity, and a surface temperature of the interior material of the spa room are all regulated to be within respective predetermined target ranges.

The lava bathing-spa device as above may further include a control device which controls the room temperature, the humidity, and the surface temperature of the interior material of the spa room.

The lava bathing-spa device as above may have the predetermined ranges set as follows:
Room temperature: 60 to 70° C.
Humidity: 40 to 60%
Surface temperature of the interior material: 45 to 65° C.

The lava bathing-spa device as above may have a predetermined range of humidity set to 45 to 60%.

The lava bathing-spa device as above may execute control to the following values in predetermined ranges as target values:
Room temperature: 65° C.
Humidity: 55%
Surface temperature of the interior material: 60° C.

In the lava bathing-spa device as above, a bedrock containing lava or predetermined ores may be used as the interior material.

The interior material of the lava bathing-spa device as above may have air permeability.

In the lava bathing-spa device as above, the bedrock may be installed at least on any one of a wall, a floor, a ceiling and a seat in the spa room.

In the interior of the spa room of the lava bathing-spa device as above, a part, which is 40% or more of a surface area and excludes the ceiling, may be created by lava or predetermined ores.

In the lava bathing-spa device as above, the bedrock containing lava or predetermined ores may be used at least for a part of the interior material, the part being a portion that contacts a user.

In the lava bathing-spa device as above, the bedrock may be used for a part of the interior material, the part being a portion that constitutes a floor and a seat on which a user is seated.

A heat/steam generating device in the lava bathing-spa device as above may include lava, a heat source for heating the lava, and a water supply tool for supplying water to the lava.

In the lava bathing-spa device as above, another stone having a composition different from that of lava may be disposed between the lava and the heat source.

The lava bathing-spa device as above may further include an automatic steam/heat generating system for automatically generating heat and steam.

The automatic steam/heat generating system in the lava bathing-spa device as above may have an automatic water-supply device for automatically supplying water to the heat/steam generating device periodically and an automatic air-blowing device for blowing air in conjunction with the automatic water-supply device.

The heating device in the lava bathing-spa device as above may include a water heater for supplying hot water and a piping through which the hot water supplied from the water heater is passed.

The heating device in the lava bathing-spa device as above may further include a hot-water temperature regulator for regulating a temperature of the hot water to be supplied.

The hot-water temperature regulator in the lava bathing-spa device as above may be so configured to regulate the temperature of the hot water to be supplied to a predetermined target temperature of the hot water.

The heating device in the lava bathing-spa device as above may further include a hot-water temperature setter for setting a target hot-water temperature on the basis of an operation by a user.

The hot-water temperature regulator in the lava bathing-spa device as above may regulate a temperature of the hot water in a hot water storage so that a surface temperature of the interior material is within a predetermined range.

In the lava bathing-spa device as above, a water bath may be also provided outside the spa room.

### Advantageous Effects of Invention

According to this disclosure, a lava bathing-spa device which is simpler and easier than conventional sauna and can be enjoyed without stress and by which a hot-bath effect of warming deep inside the body with comfort as never experienced before becomes available.

### BRIEF DESCRIPTION OF DRAWINGS

FIG. 1 is a plan view of an entire spa room illustrating an example of a lava bathing-spa device.

FIG. 2A is a plan view illustrating an example of a heat/steam generating device constituting the lava bathing-spa device.

FIG. 2B is a front view of the heat/steam generating device.

FIG. 2C is a left side view of the heat/steam generating device, illustrating a structure of a section of a part in the vicinity of a center thereof.

FIG. 3 is a perspective view illustrating an image of an example of the spa room including the lava bathing-spa device.

FIG. 4 is a perspective view when seen from another viewpoint, illustrating an image of an example of the spa room including the lava bathing-spa device.

FIG. 5 is a schematic diagram illustrating a constitution example of a heating device constituting the lava bathing-spa device.

### DESCRIPTION OF EMBODIMENTS

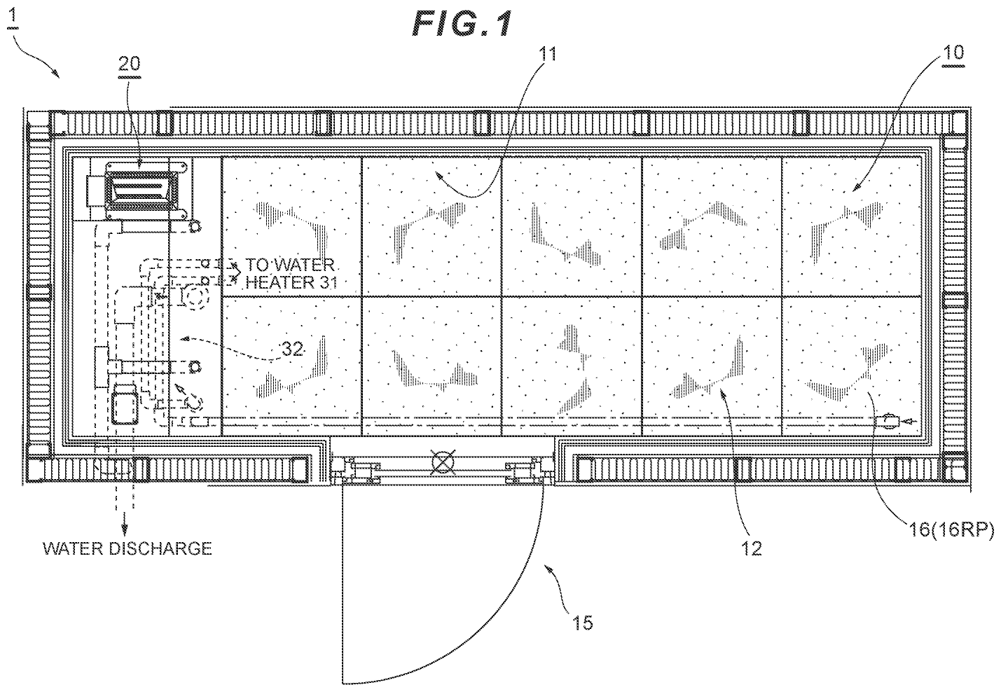

Hereinafter, a preferred embodiment of a lava bathing-spa device according to this disclosure will be explained in detail with reference to the drawings (see FIG. 1 and the like).

### [Constitution of Lava Bathing-Spa Device]

A lava bathing-spa device of this embodiment (hereinafter, referred to as a “magma-type lava bathing-spa device” in some cases) 1 is constituted as a device including, in addition to a sauna stove (heat/steam generating device) 20 and an interior material installed inside a spa room 10, a heating device 30, an auto loyly 40, and a control device 50 (see FIG. 1 and the like).

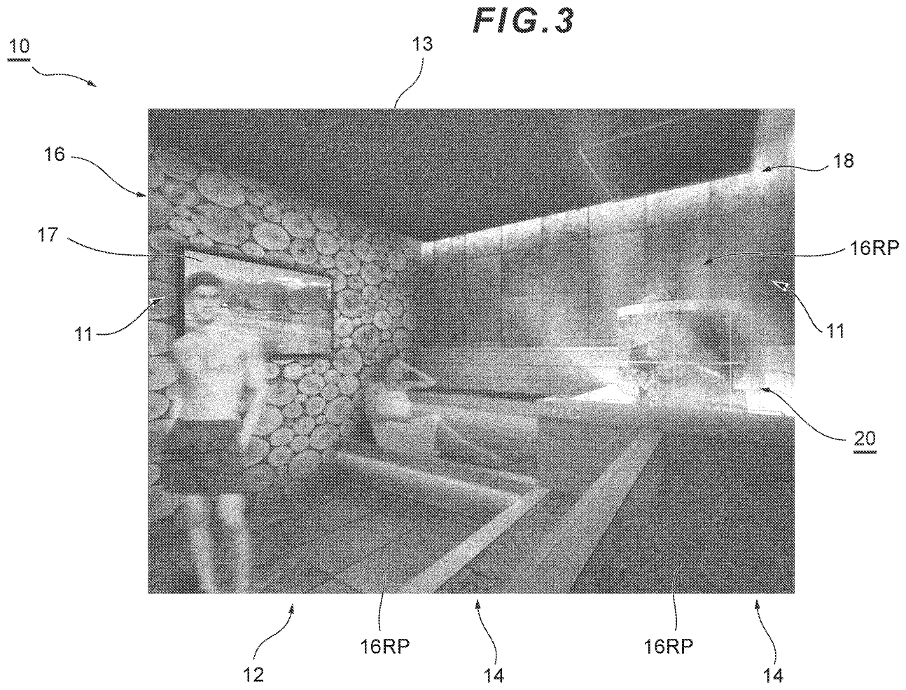

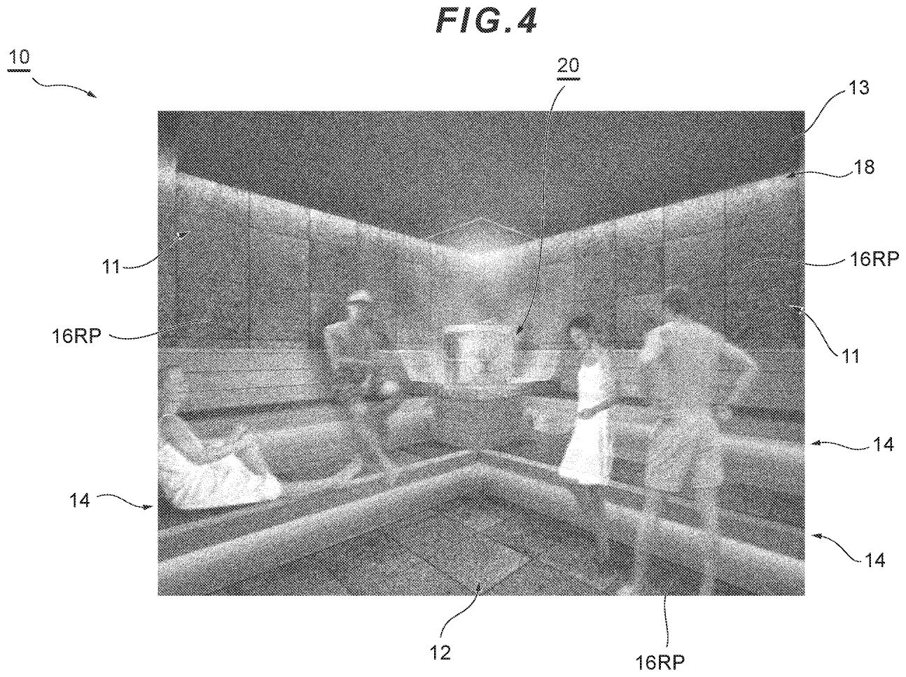

The spa room 10 is constituted by a wall 11, a floor 12, a ceiling 13, a seat 14, a door 15, an interior material 16 and the like (see FIG. 1 and the like). An entrance fixture including the door 15 may be disposed at positions indicated in FIG. 1 or may be disposed at positions other than them. Inside the spa room 10, devices which enable more comfortable stay such as an image receiver 17, a speaker (not shown), indirect lighting 18 and the like may be also disposed (see FIG. 3, FIG. 4). It is to be noted that, in the perspective view in FIG. 3, FIG. 4, upper and lower two staged seats 14 in a stepped form are illustrated, but needless to say, this is only an example.

A bedrock 16RP containing ores is used for a part of the interior material 16 portion constituting the wall 11, the floor 12, the ceiling 13, and the seat 14. The bedrock 16RP may be disposed on all the wall 11, the floor 12, the ceiling 13, and the seat 14, but it may be disposed only on any one of them such as a part of the floor 12 and the seat 14, for example (see FIGS. 3 to 5). In this embodiment, as the bedrock 16RP, those containing ores which cause a far infrared ray to be generated or specifically, those containing lava or predetermined ores are used. In general, the bedrock 16RP has air permeability. It is to be noted that, the “predetermined ores” referred to in this Description refer to ores with a high radiant heat effect of the far infrared ray such as basalt rock, for example.

Generally known merits of using the bedrock 16RP for a part of the interior material 16 in the spa room 10 include the following.
1. The body is indirectly warmed by the far-infrared ray effects given by the bedrock 16RP, whereby elevation of body temperature is prompted. In general, various types of physical deconditioning are considered to be caused by lowered body temperature (cold virus infections, allergic symptoms, maldigestion, constipation, chronic fatigue, rough skin, acne, cold sensitivity, menoxenia, infertility, poor sleep quality, shoulder stiffness, backache, gray hair, hair loss and the like), and the merits are effective in prevention and improvement of the aforementioned physical deconditioning.
2. The hyperthermia effect of the far infrared ray is considered to continue for approximately 72 hours, and as it is also called as a hot ray, the body is firmly warmed from the inside. As a result, blood circulation is promoted, and metabolism is improved. The blood circulation promotion also leads to effects of recovery of the fatigue, improvement of cold sensitivity and the like.
3. When the body is warmed from an inside, perspiration from skin's oil glands is promoted. By perspiring heavily, so-called detoxication effects that toxins and waste products in the body are released to an outside can be expected. At this time, such beauty effects are also expected that the metabolism of skin is also promoted, skin troubles are solved, beautiful skin can be obtained and the like.
4. When using, minerals contained in the lava or the like are emitted into the air by the bedrock 16RP being warmed. Vanadium contained in the minerals is considered to be effective in lowering a blood pressure, a blood glucose level, and cholesterol, which leads to effects of prevention and allegation of life-style related diseases.
5. Negative ions emitted from the lava and the like are considered to have a relaxation effect.

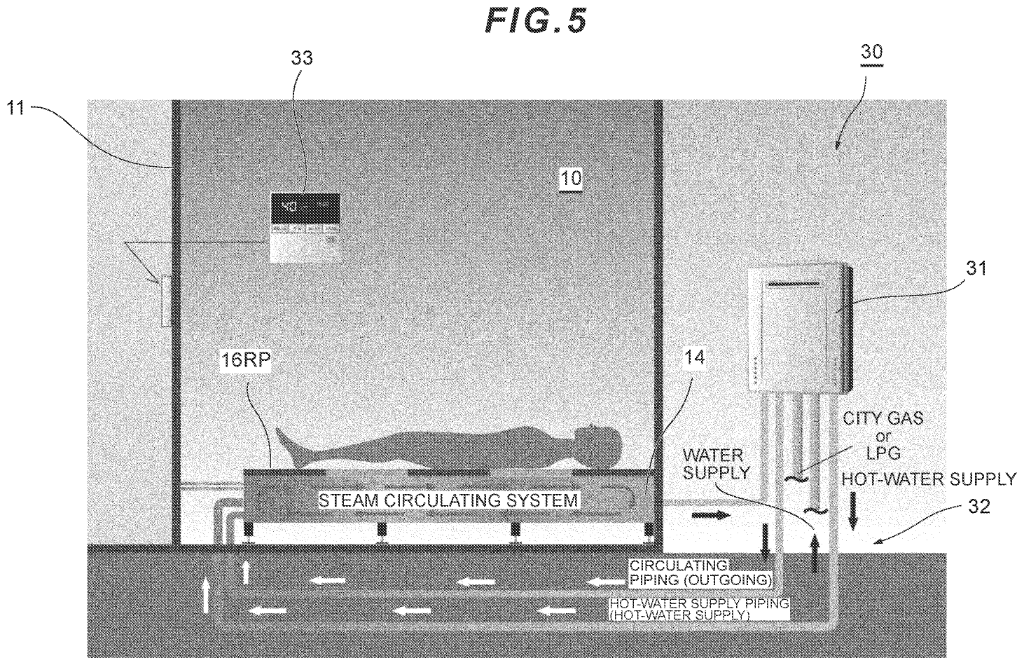

By the way, the bedrock 16RP as above does not have to be installed on all of the wall 11, the floor 12, the ceiling 13, and the seat 14 of the spa room 10, but in order to make the various actions and the effects described above in the spa room 10 more effective, a rate of the bedrock 16RP occupying the surface area in the spa room 10 is preferably a predetermined value, that is, 30% or more, for example, and is more preferably 35% or more. In this embodiment, by considering the various effects and efficacies, a part of 40% or more of the surface area and excluding the ceiling inside the spa room 10 is constructed by the bedrock 16RP containing lava or predetermined ores. Moreover, in this embodiment, the bedrock 16RP containing lava or predetermined ores is disposed on at least a part of the portion in contact with the user. The at least a part of the portion in contact with the user falls under a part of the portion constituting the floor 12 and the seat 14 on which the user is seated, for example. On the seat 14, for example, the plate-shaped bedrock 16RP (that is, the bedrock plate) can be disposed (see FIG. 4, FIG. 5 and the like).

The sauna stove 20 is installed as a device for generating heat and steam (heat/steam generating device) at any one of four corners in the spa room 10, for example (see FIG. 1). The sauna stove 20 in this embodiment includes a housing 21, a sheath heater 22 and the like. Moreover, a water supply tool 24 for supplying water to the sauna stove 20 is provided in the vicinity of the sauna stove 20.

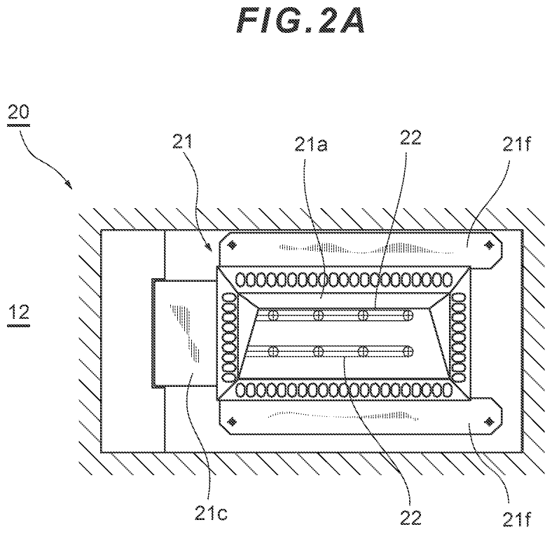

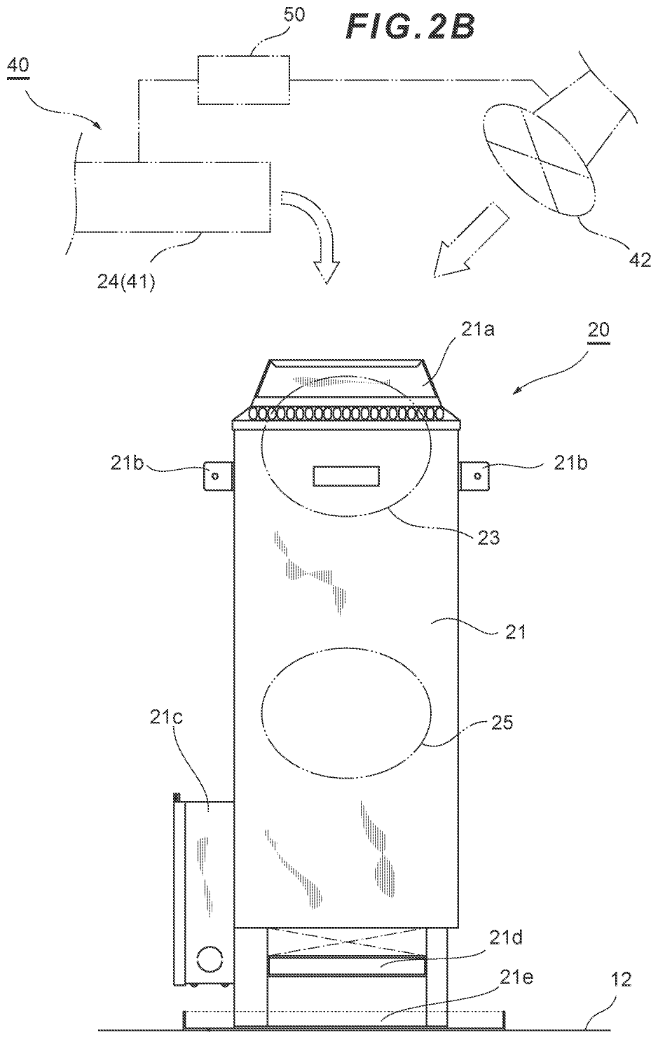

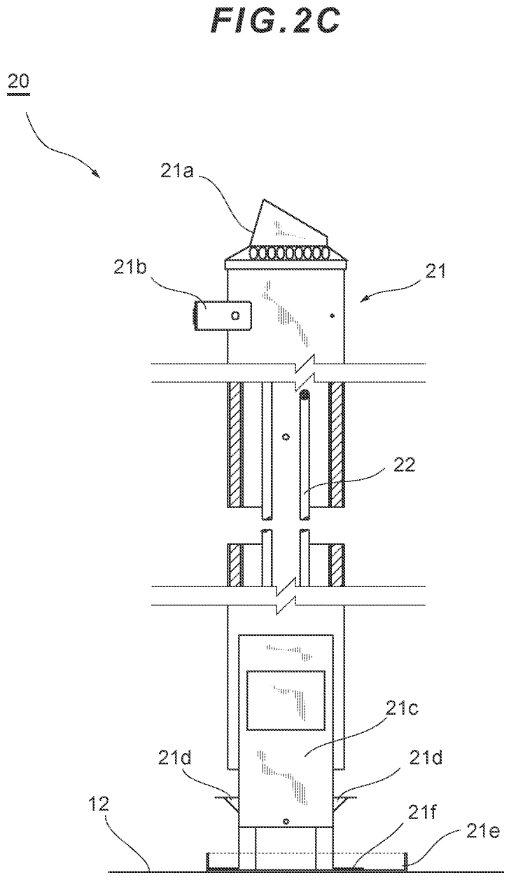

The housing 21 of the sauna stove 20 is constituted by a substantially rectangular casing on a plan view, for example, and incorporates the sheath heater 22 (see FIG. 2A and the like). Moreover, in the housing 21, a top cover 21a, an anti-vibration member 21b, a terminal box 21c, a water-receiving vat 21d, an interior-protection vat 21e, an anchor 21f and the like are provided (see FIG. 2B, FIG. 2C and the like). The top cover 21a is a perforated cover mounted on a top part of the housing 21 and becomes a target for mounting without protruding from the top cover 21a, when a stone material such as a sauna stone 25 is to be mounted in the housing 21. The anti-vibration member 21b is an angle material or the like provided on a side surface of the housing 21 and is constituted as a member for promoting stabilization of the sauna stove 20. The terminal box 21c is constituted so as to incorporate wirings and the like for supplying electricity from the outside. The water-receiving vat 21d is constituted by a box-shaped member protruding to the side and provided in the vicinity of a bottom part so as to receive water dropping to the outside of the housing 21. The interior-protection vat 21e is constituted by a shallow box-shaped member provided on the bottom part so as to protect the interior material 16 of the wall 11 and the floor 12. The anchor 21f is constituted by a flat-plate shaped rigid body mounted on the bottom part of the housing 21 and is fixed to the floor 12 by a fixing bolt or the like (see FIG. 2A).

The sheath heater 22 is a heating device (heat source) with a structure which covers a nichrome wire with a sheath-shaped member and directly or indirectly heats a stone material placed in the housing 21. As the stone material, other than the sauna stone 25, a lava 23 may also be used. In this embodiment, on the basis of such a characteristic of the lava 23 that water permeates more easily than the sauna stone 25, and the permeated water evaporates slowly, a basic disposition of the stone materials is set such that the sauna stone 25 is placed in a lower part in the housing 21 and the lava 23 in an upper part, respectively (it is to be noted that, rough positions are given numeral signs 23 and 25 to the lava 23 and the sauna stone 25, respectively, in FIG. 2B in the case of the disposition as above). In this case, most of the supplied water is sprinkled to the lava 23, and most of the water can evaporate slowly by taking time as compared with a general-type sauna stove with the sauna stone (stone with the composition different from that of the lava 23) placed above. Moreover, though not particularly shown in detail, the sauna stone 25 may be interposed between the lava 23 and the sheath heater 22. In this case, the lava 23 can be heated not directly but through the heat of the sauna stone 25.

The water supply tool 24 is installed for supplying water to a stone material placed on the sauna stove 20 (in the case of this embodiment, mainly the lava 23 placed in the upper part). As the water supply tool 24, a water tap (see FIG. 2B) installed beside the sauna stove 20 can be used, but this is only an example, and other than that, it is needless to say that containers such as a bucket and a dipper can be used as the water supply tool 24 (see FIG. 4).

The heating device 30 is provided as a device for heating the bedrock 16RP. In this embodiment, the heating device 30 including a water heater 31, a piping 32, a hot-water temperature regulator 33 and the like is used so as to heat the lava 16RP by using heat of the hot water from the inside or the back side thereof. An example of the heating device 30 as above will be explained by using drawings schematically illustrating the configuration (see FIG. 5). It is to be noted that, FIG. 5 illustrates a state in which a user is lying on the seat 14, but it is needless to say that it illustrates only an example in which the user can take a free and relaxed posture in the spa room 10.

The water heater 31 is disposed outside the spa room 10 and supplies hot water by heating water supplied from the outside into the room through the piping 32. The piping 32 is disposed circulating such that hot water supplied from the water heater 31 is supplied to the bedrock (in the example shown in FIG. 5, the bedrock installed on the seat 14) 16RP in the spa room 10 and after that, is returned to the water heater 31. It is to be noted that, in FIG. 1, a disposition example of a part of the piping 32 provided under the floor of the spa room 10 is indicated by a broken line. A specific configuration for heating the lava 16RP by using the heat of the hot water from the inside or the back side thereof is not particularly limited, and the bedrock 16RP installed on the surface of the seat 16 may be heated from the back side by using the system through which the steam is circulated inside the seat 16 (see FIG. 5), or though not particularly shown, the bedrock 16RP may be heated from the inside or the back side thereof by using the piping 32 routed inside or the back side of the bedrock 16RP.

The hot-water temperature regulator 33 is a device which regulates a temperature of the hot water supplied from the water heater 31 to a predetermined target hot-water temperature. As the hot-water temperature regulator 33, a hot-water supply remote-controller provided on a wall outside the spa room 10 is illustrated in FIG. 5, but this is an example, and other than the device with which the user can operate and regulate the temperature setting by himself/herself as above, it may be a device that can be regulated from an administrator side of the facility. According to the hot-water temperature regulator 33 as above, the hot-water supply temperature can be regulated so that a surface temperature of the bedrock 16RP falls within a predetermined range.

The auto loyly 40 is also provided as an example of a system for automatically generating heat and steam (automatic steam/heat generating system). However, a specific configuration of the auto loyly 40 is not particularly limited. In this embodiment, for example, the auto loyly 40 is configured by an automatic water-supply device 41, an automatic air-blowing device 42, and a control device 50 (see FIG. 2B). The automatic water-supply device 41 is a device for automatically supplying water regularly to the sauna stove 20 and can be constituted by automating an operation of the aforementioned water supply tool (water tap) by the control device 50, for example. The automatic air-blowing device 42 is a device for blowing air in conjunction with the automatic water-supply device 41 and can be constituted by a fan for blowing air toward the sauna stove 20, for example.

The control device 50 is a device for controlling the lava bathing-spa device 1. Though not shown in detail, the control device 50 is constituted by sensors for detecting a temperature and humidity, a regulator which feedback-controls the temperature and the humidity on the basis of detected values of the sensors and the like. The control device 50 of this embodiment controls a room temperature, humidity, and a surface temperature of the bedrock 16RP of the spa room 10. Moreover, the control device (it is needless to say that it may be another control device different from this) 50 also controls the automatic water-supply device 41 and the automatic air-blowing device 42 of the auto loyly 40 as described above.

### [Control and Provision of Indoor Environment by Lava Bathing-Spa Device]

The lava bathing-spa device (magma-type lava bathing-spa device) 1 of this embodiment is configured to control the room temperature, the humidity, and the surface temperature of the bedrock 16RP of the spa room 10 by the aforementioned control device 50 and to provide the indoor environment in which all are regulated with targets that each of them is within predetermined ranges. The predetermined ranges referred to here are as follows, for example:
Room temperature in the spa room 10:60 to 70° C.
Humidity in the spa room 10:40 to 60%
Surface temperature of the bedrock 16RP: 45 to 65° C.

A more preferable range of the humidity is 45 to 60%. The preferable ranges as above can be achieved by controlling the following values to the respective target values (in other words, can be considered to be optimal values):
Room temperature in the spa room 10:65° C.
Humidity in the spa room 10: 55%
Surface temperature of the bedrock 16RP: 60° C.

The target values or the predetermined ranges as above are, as already described, based on the new finding that, with respect to the conventional sauna with the so-called 2-axis approach by which the physical feeling and the effect are created by setting of the room temperature and the humidity, if the 3-axis approach of the room temperature, the humidity and, in addition, the far-infrared radiant heat can create a hot-bath effect, it can be enjoyed simply and easily with less stress than the conventional sauna, and comfort as never experienced before becomes available. Each of the target values (or the predetermined ranges) of the room temperature, the humidity, and the surface temperature, which can be considered to be a so-called golden ratio which has been realized on the basis of the finding as above are indicated in Table 1 (see the following) in comparison with each value in the conventional hot-bath facilities (general sauna, Magma-spa studio (Registered Trademark), and Magma-spa (Registered Trademark)) so that they can be compared easily. It is to be noted that, since as the conventional general sauna, the one without the bedrock was taken up, it does not have a temperature falling under the item of the surface temperature. For reference, the “Magma-spa studio” is a highly-functional studio, which is one of hot bath facilities having a negative ion and a growth light effect by the lava and the purpose of raising the body temperature, and the “Magma-spa” is a hot bath facility having the negative ion and the growth light effect by the lava and the purpose of raising the body temperature. According to the magma-type lava bathing-spa device 1 of this embodiment having been explained so far, it can be considered that formation of the indoor environment which could not have been provided in the conventional hot bath facilities can be sufficiently read also from the numeral values.

### [Table 1]

Regarding the magma-type lava bathing-spa device 1 of this embodiment having been explained so far, organization of the three elements, that is, the spatial temperature, the humidity, the far infrared rays as keys to lead to an unexperienced zone was conceived of, by which provision of a sense of being warmed to the deep part of the body while feeling that comfort as never experienced before is realized. A warming power created by the stone material (sauna stones and the like) reinforces the far infrared rays emitted from the lava (ores) and generates a synergic effect, and the steam effect from inside the room and the floor bottom by combination of the far infrared rays and the sauna structure forms an impeccable humidity balance. The magma-type lava bathing-spa device 1 which realizes and provides the indoor environment as above can be enjoyed simply and easily with less stress than the conventional sauna and contributes to realization of such a facility in which the hot-bath effect that can warm even deep inside the body with comfort as never experienced before can be sufficiently enjoyed.

It is to be noted that the aforementioned embodiment is an example of a preferred embodiment of the present invention but it is not limiting and can be worked with various deformations within a range not departing from the gist of the present invention. For example, it is needless to say that the lava bathing-spa device 1 having been explained so far can be used in a way that it can be used with a water bath attached outside the spa room 10.

### Embodiment 1

When two sauna lovers (so-called “saunners” in recent years) visited and experienced the facility including the magma-type lava bathing-spa device 1, the both spoke very highly of the hot-bath effect different from the conventional sauna facilities (it is not too hot inside the room, and the deep inside the body is warmed gradually) and stated that they could experience it with comfortableness different from the conventional one.

### INDUSTRIAL APPLICABILITY

The present invention is suitable to be applied to a lava bathing-spa device in a hot bath facility and the like.

### REFERENCE SIGNS LIST

1 Lava bathing-spa device
10 Spa room
11 Wall
12 Floor
13 Ceiling
14 Seat
15 Door
16 Interior material
16RP Bedrock (interior material containing ores)
17 Image receiver
18 Indirect lighting
20 Sauna stove (heat/steam generating device)
21 Housing
21a Top cover
21b Anti-vibration member
21c Terminal box
21d Water-receiving vat
21e Interior-protection vat
21f Anchor
22 Sheath heater (heat source of sauna stove (heat/steam generating device)
23 Lava
24 Water supply tool
25 Sauna stone (another stone with composition different from that of lava)
30 Heating device
31 Water heater
32 Piping
33 Hot-water temperature regulator
40 Auto loyly (automatic steam/heat generating system)
41 Automatic water-supply device
42 Automatic air-blowing device
50 Control device

1. A lava bathing-spa device, comprising:
a heat/steam generating device which is installed inside a spa room including a door capable of being opened/closed, and which generates heat and steam;
an interior material which contains ores generating far infrared rays, and which is installed in the spa room; and
a heating device which heats the interior material from an inside or a back side thereof.

2. The lava bathing-spa device according to claim 1, wherein an indoor environment is provided such that a room temperature, humidity, and a surface temperature of the interior material of the spa room are all regulated to be within respective predetermined target ranges.

3. The lava bathing-spa device according to claim 2, further comprising a control device which controls the room temperature, the humidity, and the surface temperature of the interior material of the spa room.

4. The lava bathing-spa device according to claim 3, wherein the predetermined ranges are set as follows:
(a) room temperature: 60 to 70° C.,
(b) humidity: 40 to 60%, and
(c) surface temperature of the interior material: 45 to 65° C.

5. The lava bathing-spa device according to claim 4, wherein the predetermined range of the humidity is set to 45 to 60%.

6. The lava bathing-spa device according to claim 4, wherein control is executed to the following values in the predetermined ranges as target values:
(a) room temperature: 65° C.,
(b) humidity: 55%, and
(c) surface temperature of the interior material: 60° C.

7. The lava bathing-spa device according to claim 1, wherein a bedrock containing lava or predetermined ores is used as the interior material.

8. The lava bathing-spa device according to claim 1, wherein the interior material has air permeability.

9. The lava bathing-spa device according to claim 7, wherein the bedrock is installed on at least any one of a wall, a floor, a ceiling and a seat in the spa room.

10. The lava bathing-spa device according to claim 1, wherein a part, which is 40% or more of a surface area and excludes the ceiling, of the spa room is created by lava or predetermined ores.

11. The lava bathing-spa device according to claim 10, wherein the bedrock containing the lava or predetermined ores is used for at least a part of the interior material, the part being a portion that contacts a user.

12. The lava bathing-spa device according to claim 11, wherein the bedrock is used for a part of the interior material, the part being a portion that constitutes a floor and a seat on which the user is seated.

13. The lava bathing-spa device according to claim 1, wherein the heat/steam generating device includes lava, a heat source which heats the lava, and a water supply tool which supplies water to the lava.

14. The lava bathing-spa device according to claim 13, wherein another stone having a composition different from that of the lava is disposed between the lava and the heat source.

15. The lava bathing-spa device according to claim 1, further comprising an automatic steam/heat generating system which automatically causes the heat and the steam to be generated.

16. The lava bathing-spa device according to claim 15, wherein the automatic steam/heat generating system has an automatic water-supply device which automatically supplies water to the heat/steam generating device periodically and an automatic air-blowing device which blows air in conjunction with the automatic water-supply device.

17. The lava bathing-spa device according to claim 1, wherein the heating device includes a water heater which supplies hot water and a piping through which the hot water supplied from the water heater is passed.

18. The lava bathing-spa device according to claim 17, wherein the heating device further includes a hot-water temperature regulator which regulates a temperature of the hot water to be supplied.

19. The lava bathing-spa device according to claim 18, wherein the hot-water temperature regulator regulates the temperature of the hot water to be supplied to a predetermined target hot-water temperature.

20. The lava bathing-spa device according to claim 19, wherein the heating device further includes a hot-water temperature setter which sets the target hot-water temperature on the basis of an operation by a user.

21. The lava bathing-spa device according to claim 19, wherein the hot-water temperature regulator regulates a temperature of hot water in the water heater such that a surface temperature of the interior material is within a predetermined range.

22. The lava bathing-spa device according to claim 1, wherein a water bath is also provided outside the spa room.
